(19) United States
(12) Patent Application Publication
(10) Pub. No.: US 2024/0419817 A1
(43) Pub. Date: Dec. 19, 2024

(54) FRAMEWORK TO REQUEST AND GRANT ACCESS TO PROTECTED RESOURCES

(71) Applicant: Snowflake Inc., Bozeman, MT (US)

(72) Inventors: Karol Pawel Bienkowski, Toronto (CA); Benoit Dageville, San Mateo, CA (US); Scott C. Gray, Richmond Hill (CA); Unmesh Jagtap, San Mateo, CA (US); Anton Yafremau, Newmarket (CA); Alan Jinsoo Yu, Issaquah, WA (US)

(21) Appl. No.: 18/478,539

(22) Filed: Sep. 29, 2023

Related U.S. Application Data
(60) Provisional application No. 63/507,929, filed on Jun. 13, 2023.

(51) Int. Cl. G06F 21/60; G06F 9/451

(52) U.S. Cl. CPC G06F 21/604; G06F 9/451; G06F 2221/2141

(57) ABSTRACT

A data platform grants privileges to applications accessing resources of the data platform in a secure and efficient way. The data platform determines whether a privilege has been granted to an application and, if not, generates a validation of the request to grant the privilege using a manifest of the application. The data platform generates a grant privilege request user interface, presents the grant privilege user interface to a consumer of the data platform, receives a privilege grant authorization from the consumer, and grants the privilege to the application. The granted privilege is then used by the application to access the resource.

### PRIORITY CLAIM

This application claims the benefit of priority to U.S. Provisional Patent Application Ser. No. 63/507,929filed Jun. 13, 2023, the contents of which are hereby incorporated in their entirety.

### TECHNICAL FIELD

Examples of the disclosure relate generally to data platforms and, more specifically, to requesting and granting access to resources on data platforms.

### BACKGROUND

Data platforms are widely used for data storage and data access in computing and communication contexts. With respect to architecture, a data platform could be an on-premises data platform, a network-based data platform (e.g., a cloud-based data platform), a combination of the two, and/or include another type of architecture. With respect to type of data processing, a data platform could implement online transactional processing (OLTP), online analytical processing (OLAP), a combination of the two, and/or another type of data processing. Moreover, a data platform could be or include a relational database management system (RDBMS) and/or one or more other types of database management systems. Management of a database is facilitated, in part, by granting access to resources.

### BRIEF DESCRIPTION OF THE DRAWINGS

The present disclosure will be understood more fully from the detailed description given below and from the accompanying drawings of various examples of the disclosure.

FIG. 1 illustrates an example computing environment that includes a network-based data platform in communication with a cloud storage provider system, in accordance with some examples.

FIG. 2 is a block diagram illustrating components of a compute service manager, in accordance with some examples.

FIG. 3 is a block diagram illustrating components of an execution platform, in accordance with some examples.

FIG. 4A is a collaboration diagram of components of a data platform, in accordance with some examples.

FIG. 4B is a sequence diagram of an access granting method used by components of a data platform, in accordance with some examples.

FIG. 4C is an activity diagram of an access granting method, in accordance with some examples.

FIG. 5 is an illustration of an account privileges request UI for requesting a grant of an account privilege, in accordance with some examples.

FIG. 6 is an illustration of a reference request interface for requesting a reference fulfillment to access to one or more objects using references, in accordance with some examples.

FIG. 7 is an illustration of an object access request interface for requesting privileges to one or more objects, in accordance with some examples.

FIG. 8 is an illustration of an API integration request interface for requesting the use of an API integration to an external resource, in accordance with some examples.

FIG. 9 illustrates a diagrammatic representation of a machine in the form of a computer system within which a set of instructions may be executed for causing the machine to perform any one or more of the methodologies discussed herein, in accordance with some examples.

### DETAILED DESCRIPTION

A data platform may provide for data product providers to provide applications to data product consumers. When the applications run on the data platform, the applications use privileges granted to the applications by the consumers. Granting of these privileges can be problematic from a consumer perspective and also from a security perspective. Sometimes, consumers have to lookup documentation of the application provided by the provider and execute a script of commands manually before using the applications. Some providers workaround this problem by giving the consumers stored procedures that emit SQL commands for consumers to run. Other providers request elevated privileges, such as an administrator privilege of an account administrator role, to eliminate this customer friction and thus end up gaining superuser rights for the entire lifecycle of the application in the consumer accounts which is a security problem for the consumer accounts. In addition, functionality of an application may be adversely affected during an update. For example, consider an application that exposes a stored procedure to the consumer that they run on a regular basis automatically. Assume that a new version of the stored procedure needs additional permissions from consumers. There is no way for the new stored procedure to continue functioning gracefully until new permissions are granted to the stored procedure. The providers may circumvent this problem by creating a stored procedure with new functionality so that the existing consumers are not broken. This adds significant friction to maintaining and developing applications. Sometimes, an application may need an external function for looking up internal metadata or an Application Programming Interface (API) integration that consumers have to create at setup time, thus leaking the implementation details of the application to the consumers.

In some examples, a data platform that implements the methodologies of this disclosure provides for consumer control of a privilege granting process. Consumers explicitly opt-in for all new capabilities of an application that they should be concerned with from a security perspective.

In some examples, applications degrade gracefully as they will be able to function gracefully until new privileged actions are signed off by the consumer.

In some examples, consumers do not need to set up applications or grant permissions to the application by leaving the application User Interface (UI) or executing scripts generated by the application.

In some examples, an application can perform privileged actions such as executing tasks and creating objects in the consumer account based on permissions granted to the application by the consumer.

In some examples, permissible privileges are specified in a manifest file. These privileges are granted to the application at version setup time by the consumer. In some examples, the privileges are granted by the consumer at run time.

In some examples, an application can access one or more objects of a specific type in the consumer account declared as references in the manifest file. Consumers create and pass persistable references to the application that are then associated with the references in the manifest and used in the application logic.

In some examples, the methodologies described herein relate to a computer-implemented method including: determining, by at least one processor, whether a privilege for accessing a resource of a data platform has been granted to an application of the data platform; and in response to determining that the privilege has not been granted to the application, performing operations including: receiving, by the at least one processor, a request to grant the privilege to the application; generating, by the at least one processor, a validation of the request to grant the privilege to the application using a manifest of the application; and in response to the validation, performing operations including: generating, by the at least one processor, a grant privilege request UI using the request to grant the privilege; presenting, by the at least one processor, the grant privilege request UI to a consumer of the data platform; receiving, by the at least one processor, a privilege grant authorization from the consumer; granting, by the at least one processor, the privilege to the application; and using, by the at least one processor, the privilege to use the resource.

In some examples, a data platform determines whether a privilege for accessing a resource has been granted to an application. In response to determining the privilege has not been granted, the data platform receives a request to grant the privilege, generates a validation of the request using the application's manifest, and generates a grant privilege request UI. The data platform presents the UI to a consumer, receives authorization from the consumer, grants the privilege to the application, and allows the application to use the privilege to access the resource.

In some examples, the resource accessed comprises an account privilege.

In some examples, the resource accessed comprises an object owned by the consumer.

In some examples, the manifest specifies privileges the application can request.

In some examples, the data platform generates the validation by decoding a request payload and validating the structure.

In some examples, the data platform highlights specifically requested privileges when presenting the UI.

In some examples, the data platform grants the privilege using a SQL command upon approval by the data product consumer.

In some examples, if the privilege is already granted, the data platform allows the application to access the resource.

In some examples, the data platform generates the UI by retrieving metadata from the manifest and displaying it to the consumer.

In some examples, the consumer is an administrator of an account on the data platform.

Reference will now be made in detail to specific examples for carrying out the inventive subject matter. Examples of these specific examples are illustrated in the accompanying drawings, and specific details are set forth in the following description in order to provide a thorough understanding of the subject matter. It will be understood that these examples are not intended to limit the scope of the claims to the illustrated examples. On the contrary, they are intended to cover such alternatives, modifications, and equivalents as may be included within the scope of the disclosure.

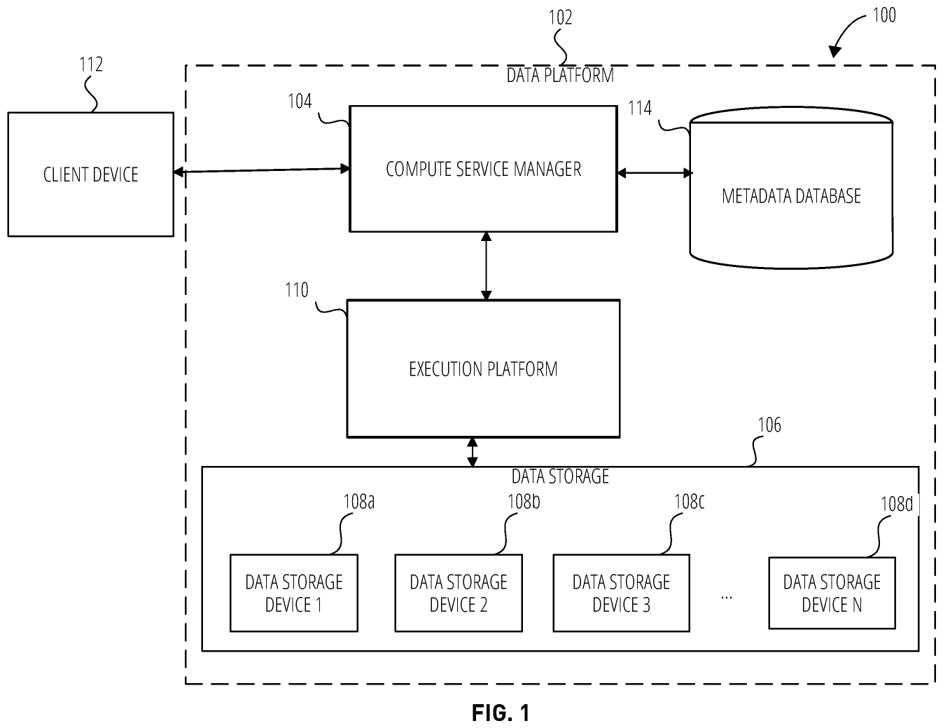

FIG. 1 illustrates an example computing environment 100 that includes a data platform 102 in communication with a client device 112, in accordance with some examples. To avoid obscuring the inventive subject matter with unnecessary detail, various functional components that are not germane to conveying an understanding of the inventive subject matter have been omitted from FIG. 1. However, a skilled artisan will readily recognize that various additional functional components may be included as part of the computing environment 100 to facilitate additional functionality that is not specifically described herein.

As shown, the data platform 102 comprises a data storage 106, a compute service manager 104, an execution platform 110, and a metadata database 114. The data storage 106 comprises a plurality of computing machines and provides on-demand computer system resources such as data storage and computing power to the data platform 102. As shown, the data storage 106 comprises multiple data storage devices, such as data storage device 1 108a, data storage device 2 108b, data storage device 3 108c, and data storage device N 108d. In some examples, the data storage devices 1 to N are cloud-based storage devices located in one or more geographic locations. For example, the data storage devices 1 to N may be part of a public cloud infrastructure or a private cloud infrastructure. The data storage devices 1 to N may be hard disk drives (HDDs), solid state drives (SSDs), storage clusters, Amazon S3™ storage systems or any other data storage technology. Additionally, the data storage 106 may include distributed file systems (e.g., Hadoop Distributed File Systems (HDFS)), object storage systems, and the like.

The data platform 102 is used for reporting and analysis of integrated data from one or more disparate sources including the storage devices 1 to N within the data storage 106. The data platform 102 hosts and provides data reporting and analysis services to multiple consumer accounts. Administrative users can create and manage identities (e.g., users, roles, and groups) and use privileges to allow or deny access to identities to resources and services. Generally, the data platform 102 maintains numerous consumer accounts for numerous respective consumers. The data platform 102 maintains each consumer account in one or more storage devices of the data storage 106. Moreover, the data platform 102 may maintain metadata associated with the consumer accounts in the metadata database 114. Each consumer account includes multiple objects with examples including users, roles, privileges, a datastores or other data locations (herein termed a “stage” or “stages”), and the like.

The compute service manager 104 coordinates and manages operations of the data platform 102. The compute service manager 104 also performs query optimization and compilation as well as managing clusters of compute services that provide compute resources (also referred to as “virtual warehouses”). The compute service manager 104 can support any number and type of clients such as end users providing data storage and retrieval requests, system administrators managing the systems and methods described herein, and other components/devices that interact with compute service manager 104. As an example, the compute service manager 104 is in communication with the client device 112. The client device 112 can be used by a user of one of the multiple consumer accounts supported by the data platform 102 to interact with and utilize the functionality of the data platform 102. In some examples, the compute service manager 104 does not receive any direct communications from the client device 112 and only receives communications concerning jobs from a queue within the data platform 102.

The compute service manager 104 is also coupled to metadata database 114. The metadata database 114 stores data pertaining to various functions and examples associated with the data platform 102 and its users. In some examples, the metadata database 114 includes a summary of data stored in remote data storage systems as well as data available from a local cache. In some examples, the metadata database 114 may include information regarding how data is organized in remote data storage systems (e.g., the database storage 106) and the local caches. In some examples, the metadata database 114 includes data of metrics describing usage and access by providers and consumers of the data stored on the data platform 102. In some examples, the metadata database 114 allows systems and services to determine whether a piece of data needs to be accessed without loading or accessing the actual data from a storage device.

The compute service manager 104 is further coupled to the execution platform 110, which provides multiple computing resources that execute various data storage and data retrieval tasks. The execution platform 110 is coupled to the database storage 106. The execution platform 110 comprises a plurality of compute nodes. A set of processes on a compute node executes a query plan compiled by the compute service manager 104. The set of processes can include: a first process to execute the query plan; a second process to monitor and delete micro-partition files using a least recently used (LRU) policy and implement an out of memory (OOM) error mitigation process; a third process that extracts health information from process logs and status to send back to the compute service manager 104; a fourth process to establish communication with the compute service manager 104 after a system boot; and a fifth process to handle all communication with a compute cluster for a given job provided by the compute service manager 104 and to communicate information back to the compute service manager 104 and other compute nodes of the execution platform 110.

In some examples, communication links between elements of the computing environment 100 are implemented via one or more data communication networks. These data communication networks may utilize any communication protocol and any type of communication medium. In some examples, the data communication networks are a combination of two or more data communication networks (or sub-networks) coupled to one another. In alternate examples, these communication links are implemented using any type of communication medium and any communication protocol.

As shown in FIG. 1, the data storage devices data storage device 1 108a to data storage device N 108d are decoupled from the computing resources associated with the execution platform 110. This architecture supports dynamic changes to the data platform 102 based on the changing data storage/retrieval needs as well as the changing needs of the users and systems. The support of dynamic changes allows the data platform 102 to scale quickly in response to changing demands on the systems and components within the data platform 102. The decoupling of the computing resources from the data storage devices supports the storage of large amounts of data without requiring a corresponding large amount of computing resources. Similarly, this decoupling of resources supports a significant increase in the computing resources utilized at a particular time without requiring a corresponding increase in the available data storage resources.

The compute service manager 104, metadata database 114, execution platform 110, and data storage 106 are shown in FIG. 1 as individual discrete components. However, each of the compute service manager 104, metadata database 114, execution platform 110, and data storage 106 may be implemented as a distributed system (e.g., distributed across multiple systems/platforms at multiple geographic locations). Additionally, each of the compute service manager 104, metadata database 114, execution platform 110, and data storage 106 can be scaled up or down (independently of one another) depending on changes to the requests received and the changing needs of the data platform 102. Thus, in the described examples, the data platform 102 is dynamic and supports regular changes to meet the current data processing needs.

During operation, the data platform 102 processes multiple jobs determined by the compute service manager 104. These jobs are scheduled and managed by the compute service manager 104 to determine when and how to execute the job. For example, the compute service manager 104 may divide the job into multiple discrete tasks and may determine what data is needed to execute each of the multiple discrete tasks. The compute service manager 104 may assign each of the multiple discrete tasks to one or more nodes of the execution platform 110 to process the task. The compute service manager 104 may determine what data is needed to process a task and further determine which nodes within the execution platform 110 are best suited to process the task. Some nodes may have already cached the data needed to process the task and, therefore, be a good candidate for processing the task. Metadata stored in the metadata database 114 assists the compute service manager 104 in determining which nodes in the execution platform 110 have already cached at least a portion of the data needed to process the task. One or more nodes in the execution platform 110 process the task using data cached by the nodes and, if necessary, data retrieved from the data storage 106. It is desirable to retrieve as much data as possible from caches within the execution platform 110 because the retrieval speed is typically faster than retrieving data from the data storage 106.

As shown in FIG. 1, the computing environment 100 separates the execution platform 110 from the data storage 106. In this arrangement, the processing resources and cache resources in the execution platform 110 operate independently of the database storage devices data storage device 1 108a to data storage device N 108d in the data storage 106. Thus, the computing resources and cache resources are not restricted to a specific one of the data storage device 1 108a to data storage device N 108d. Instead, all computing resources and all cache resources may retrieve data from, and store data to, any of the data storage resources in the data storage 106.

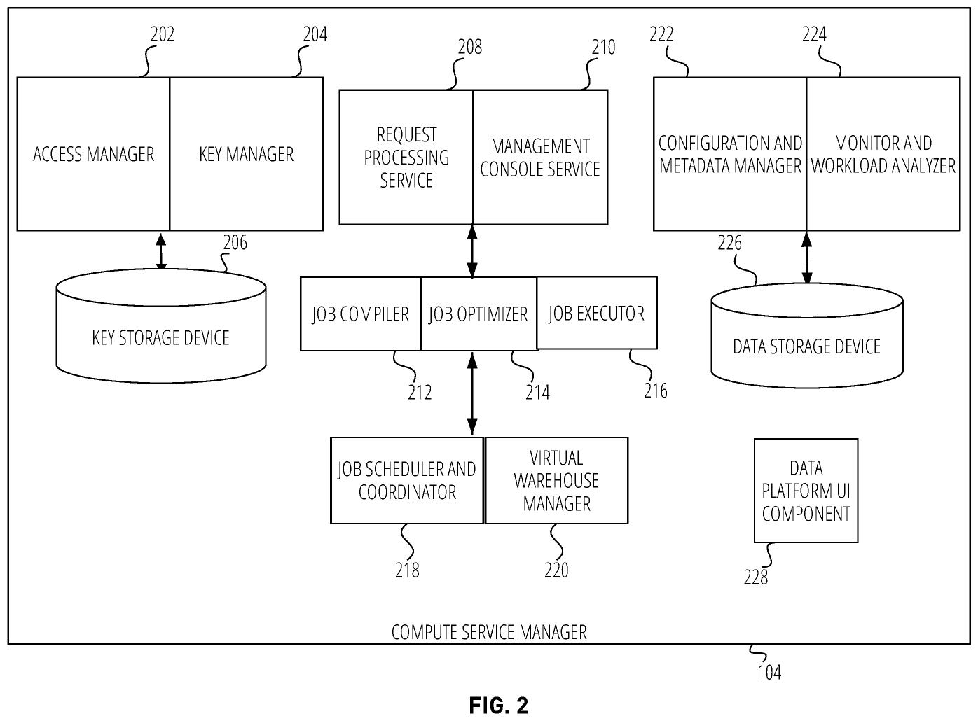

FIG. 2 is a block diagram illustrating components of the compute service manager 104, in accordance with some examples. As shown in FIG. 2, the compute service manager 104 includes an access manager 202 and a key manager 204 coupled to a key storage device 206. Access manager 202 handles authentication and authorization tasks for the systems described herein. Key manager 204 manages storage and authentication of keys used during authentication and authorization tasks. For example, access manager 202 and key manager 204 manage the keys used to access data stored in remote storage devices (e.g., data storage devices in data storage 106). As used herein, the remote storage devices may also be referred to as “persistent storage devices” or “shared storage devices.”

A request processing service 208 manages received data storage requests and data retrieval requests (e.g., jobs to be performed on database data). For example, the request processing service 208 may determine the data necessary to process a received query (e.g., a data storage request or data retrieval request). The data may be stored in a cache within the execution platform 110 or in a data storage device in data storage 106.

A management console service 210 supports access to various systems and processes by administrators and other system managers. Additionally, the management console service 210 may receive a request to execute a job and monitor the workload on the system.

The compute service manager 104 also includes a job compiler 212, a job optimizer 214, and a job executor 216. The job compiler 212 parses a job into multiple discrete tasks and generates the execution code for each of the multiple discrete tasks. The job optimizer 214 determines the best method to execute the multiple discrete tasks based on the data that needs to be processed. The job optimizer 214 also handles various data pruning operations and other data optimization techniques to improve the speed and efficiency of executing the job. The job executor 216 executes the execution code for jobs received from a queue or determined by the compute service manager 104.

A job scheduler and coordinator 218 sends received jobs to the appropriate services or systems for compilation, optimization, and dispatch to the execution platform 110. For example, jobs may be prioritized and processed in that prioritized order. In some examples, the job scheduler and coordinator 218 determines a priority for internal jobs that are scheduled by the compute service manager 104 with other “outside” jobs such as user queries that may be scheduled by other systems in the database but may utilize the same processing resources in the execution platform 110. In some examples, the job scheduler and coordinator 218 identifies or assigns particular nodes in the execution platform 110 to process particular tasks. A virtual warehouse manager 220 manages the operation of multiple virtual warehouses implemented in the execution platform 110. As discussed below, each virtual warehouse includes multiple execution nodes that each include a cache and a processor.

Additionally, the compute service manager 104 includes a configuration and metadata manager 222, which manages the information related to the data stored in the remote data storage devices and in the local caches (e.g., the caches in execution platform 110). The configuration and metadata manager 222 uses the metadata to determine which data micro-partitions need to be accessed to retrieve data for processing a particular task or job. A monitor and workload analyzer 224 oversees processes performed by the compute service manager 104 and manages the distribution of tasks (e.g., workload) across the virtual warehouses and execution nodes in the execution platform 110. The monitor and workload analyzer 224 also redistributes tasks, as needed, based on changing workloads throughout the data platform 102 and may further redistribute tasks based on a user (e.g., “external”) query workload that may also be processed by the execution platform 110. The configuration and metadata manager 222 and the monitor and workload analyzer 224 are coupled to a data storage device 226. Data storage device 226 in FIG. 2 represents any data storage device within the data platform 102. For example, data storage device 226 may represent caches in execution platform 110, storage devices in data storage 106, or any other storage device.

The compute service manager 104 validates all communication from an execution platform (e.g., the execution platform 110) to validate that the content and context of that communication are consistent with the task(s) known to be assigned to the execution platform. For example, an instance of the execution platform executing a query A should not be allowed to request access to data-source D (e.g., data storage device 226) that is not relevant to query A. Similarly, a given execution node (e.g., execution node 1 304a) may need to communicate with another execution node (e.g., execution node 2 304b), and should be disallowed from communicating with a third execution node (e.g., execution node 1 316a) and any such illicit communication can be recorded (e.g., in a log or other location). Also, the information stored on a given execution node is restricted to data relevant to the current query and any other data is unusable, rendered so by destruction or encryption where the key is unavailable.

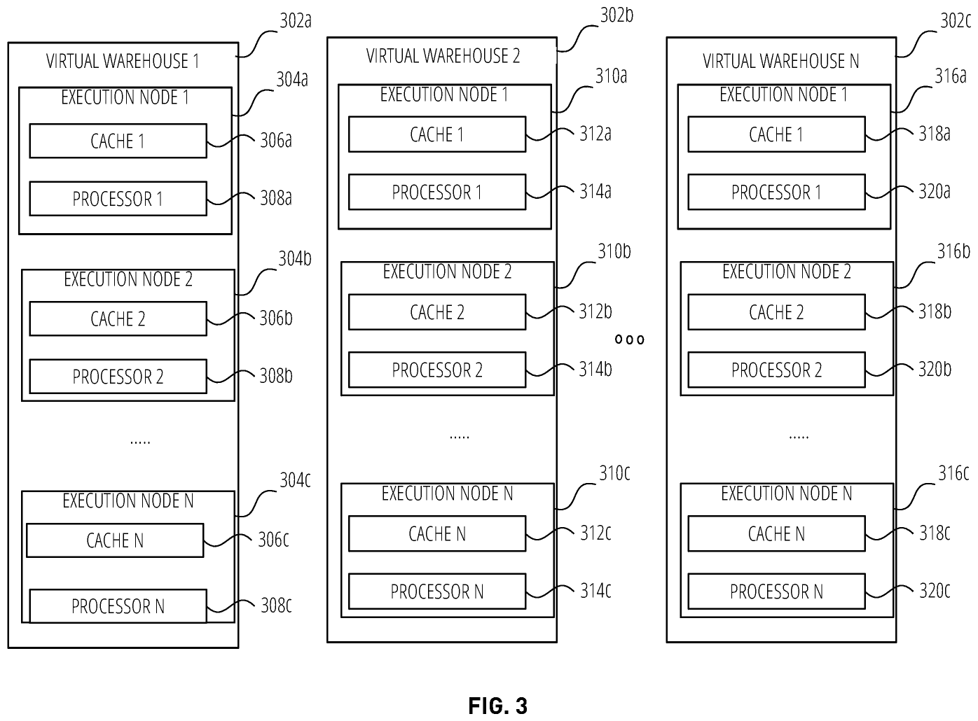

FIG. 3 is a block diagram illustrating components of the execution platform 110, in accordance with some examples. As shown in FIG. 3, the execution platform 110 includes multiple virtual warehouses, including virtual warehouse 1 302a, and virtual warehouse 2 302b to virtual warehouse N 302c. Each virtual warehouse includes multiple execution nodes that each includes a data cache and a processor. The virtual warehouses can execute multiple tasks in parallel by using the multiple execution nodes. As discussed herein, the execution platform 110 can add new virtual warehouses and drop existing virtual warehouses in real time based on the current processing needs of the systems and users. This flexibility allows the execution platform 110 to quickly deploy large amounts of computing resources when needed without being forced to continue paying for those computing resources when they are no longer needed. All virtual warehouses can access data from any data storage device (e.g., any storage device in data storage 106).

Although each virtual warehouse shown in FIG. 3 includes three execution nodes, a particular virtual warehouse may include any number of execution nodes. Further, the number of execution nodes in a virtual warehouse is dynamic, such that new execution nodes are created when additional demand is present, and existing execution nodes are deleted when they are no longer necessary.

Each virtual warehouse is capable of accessing any of the data storage devices 1 to N shown in FIG. 1. Thus, the virtual warehouses are not necessarily assigned to a specific data storage device 1 to N and, instead, can access data from any of the data storage devices 1 to N within the data storage 106. Similarly, each of the execution nodes shown in FIG. 3 can access data from any of the data storage devices 1 to N. In some examples, a particular virtual warehouse or a particular execution node may be temporarily assigned to a specific data storage device, but the virtual warehouse or execution node may later access data from any other data storage device.

In the example of FIG. 3, virtual warehouse 1 302a includes a plurality of execution nodes as exemplified by execution node 1 304a, execution node 2 304b, and execution node N 304c. Execution node 1 304a includes cache 1 306a and a processor 1 308a. Execution node 2 304b includes cache 2 306b and processor 2 308b. Execution node N 304c includes cache N 306c and processor N 308c. Each execution node 1 to N is associated with processing one or more data storage and/or data retrieval tasks. For example, a virtual warehouse may handle data storage and data retrieval tasks associated with an internal service, such as a clustering service, a materialized view refresh service, a file compaction service, a storage procedure service, or a file upgrade service. In other implementations, a particular virtual warehouse may handle data storage and data retrieval tasks associated with a particular data storage system or a particular category of data.

Similar to virtual warehouse 1 302a discussed above, virtual warehouse 2 302b includes a plurality of execution nodes as exemplified by execution node 1 310a, execution node 2 310b, and execution node N 310c. Execution node 1 310a includes cache 1 312a and processor 1 314a. Execution node 2 310b includes cache 2 312b and processor 2 314b. Execution node N 310c includes cache N 312c and processor N 314c. Additionally, virtual warehouse N 302c includes a plurality of execution nodes as exemplified by execution node 1 316a, execution node 2 316b, and execution node N 316c. Execution node 1 316a includes cache 1 318a and processor 1 320a. Execution node 2 316b includes cache 2 318b and processor 2 320b. Execution node N 316c includes cache N 318c and processor N 320c.

In some examples, the execution nodes shown in FIG. 3 are stateless with respect to the data the execution nodes are caching. For example, these execution nodes do not store or otherwise maintain state information about the execution node or the data being cached by a particular execution node. Thus, in the event of an execution node failure, the failed node can be transparently replaced by another node. Since there is no state information associated with the failed execution node, the new (replacement) execution node can easily replace the failed node without concern for recreating a particular state.

Although the execution nodes shown in FIG. 3 each includes one data cache and one processor, alternate examples may include execution nodes containing any number of processors and any number of caches. Additionally, the caches may vary in size among the different execution nodes. The caches shown in FIG. 3 store, in the local execution node, data that was retrieved from one or more data storage devices in data storage 106. Thus, the caches reduce or eliminate the bottleneck problems occurring in platforms that consistently retrieve data from remote storage systems. Instead of repeatedly accessing data from the remote storage devices, the systems and methods described herein access data from the caches in the execution nodes, which is significantly faster and avoids the bottleneck problem discussed above. In some examples, the caches are implemented using high-speed memory devices that provide fast access to the cached data. Each cache can store data from any of the storage devices in the data storage 106.

Further, the cache resources and computing resources may vary between different execution nodes. For example, one execution node may contain significant computing resources and minimal cache resources, making the execution node useful for tasks that require significant computing resources. Another execution node may contain significant cache resources and minimal computing resources, making this execution node useful for tasks that require caching of large amounts of data. Yet another execution node may contain cache resources providing faster input-output operations, useful for tasks that require fast scanning of large amounts of data. In some examples, the cache resources and computing resources associated with a particular execution node are determined when the execution node is created, based on the expected tasks to be performed by the execution node.

Additionally, the cache resources and computing resources associated with a particular execution node may change over time based on changing tasks performed by the execution node. For example, an execution node may be assigned more processing resources if the tasks performed by the execution node become more processor-intensive. Similarly, an execution node may be assigned more cache resources if the tasks performed by the execution node require a larger cache capacity.

Although virtual warehouses 1, 2, and N are associated with the same execution platform 110, the virtual warehouses may be implemented using multiple computing systems at multiple geographic locations. For example, virtual warehouse 1 can be implemented by a computing system at a first geographic location, while virtual warehouses 2 and N are implemented by another computing system at a second geographic location. In some examples, these different computing systems are cloud-based computing systems maintained by one or more different entities.

Additionally, each virtual warehouse as shown in FIG. 3 has multiple execution nodes. The multiple execution nodes associated with each virtual warehouse may be implemented using multiple computing systems at multiple geographic locations. For example, an instance of virtual warehouse 1 302a implements execution node 1 304a and execution node 2 304b on one computing platform at a geographic location and implements execution node N 304c at a different computing platform at another geographic location. Selecting particular computing systems to implement an execution node may depend on various factors, such as the level of resources needed for a particular execution node (e.g., processing resource requirements and cache requirements), the resources available at particular computing systems, communication capabilities of networks within a geographic location or between geographic locations, and which computing systems are already implementing other execution nodes in the virtual warehouse.

A particular execution platform 110 may include any number of virtual warehouses. Additionally, the number of virtual warehouses in a particular execution platform is dynamic, such that new virtual warehouses are created when additional processing and/or caching resources are needed. Similarly, existing virtual warehouses may be deleted when the resources associated with the virtual warehouse are no longer necessary.

In some examples, the virtual warehouses may operate on the same data in data storage 106, but each virtual warehouse has its own execution nodes with independent processing and caching resources. This configuration allows requests on different virtual warehouses to be processed independently and with no interference between the requests. This independent processing, combined with the ability to dynamically add and remove virtual warehouses, supports the addition of new processing capacity for new users without impacting the performance observed by the existing users.

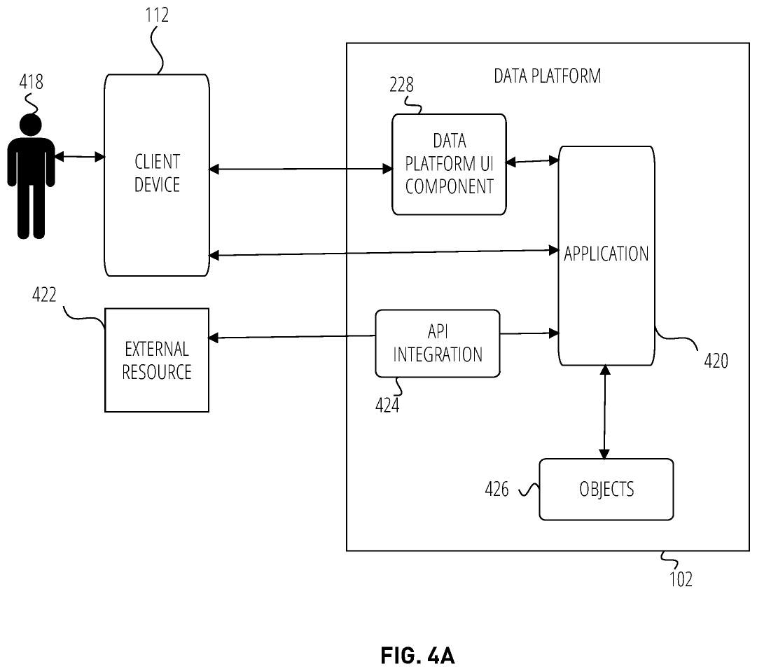

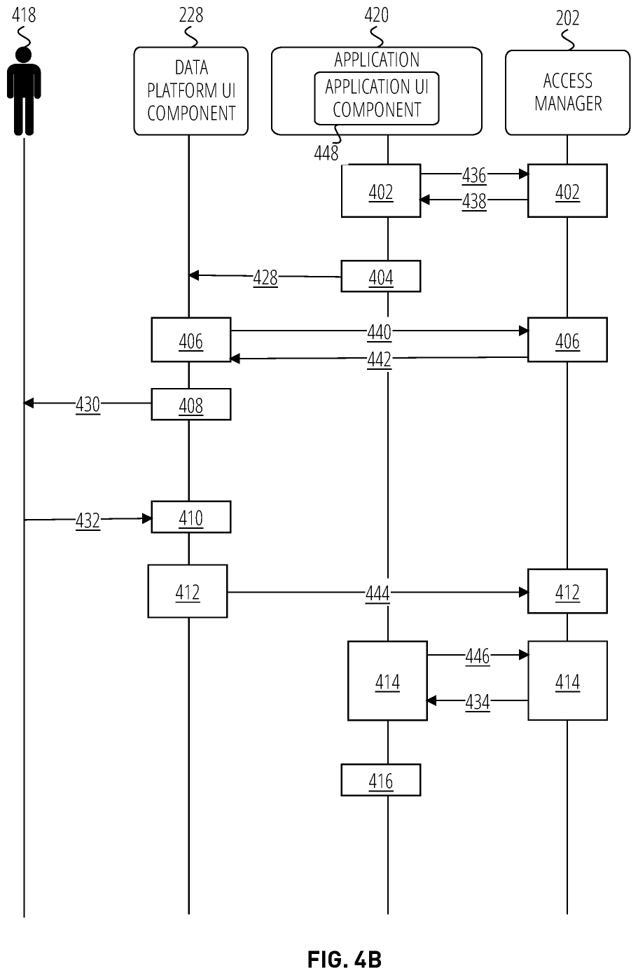

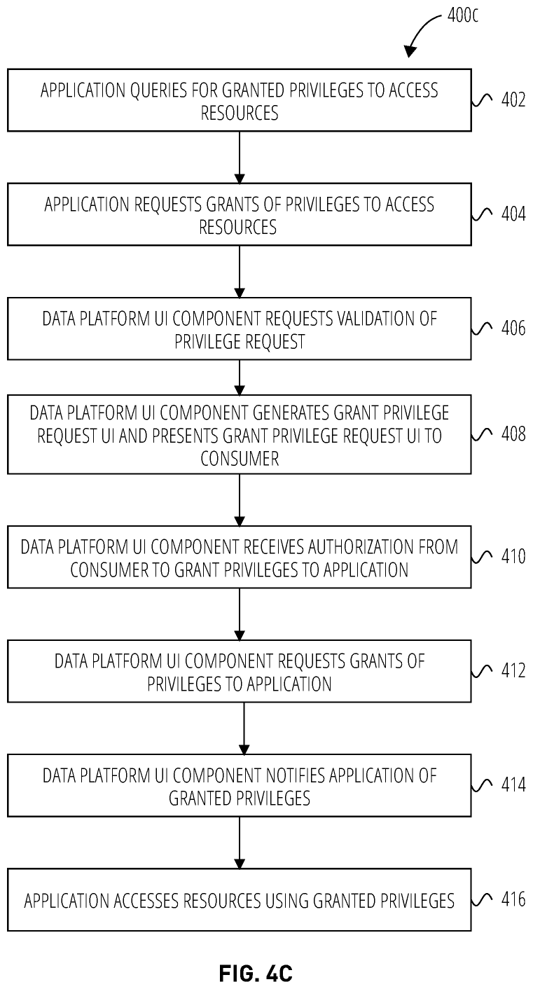

FIG. 4A is a collaboration diagram of components of a data platform 102, in accordance with some examples. A data platform 102 uses the access granting method 400c (as shown in FIG. 4C) to grant an application 420 access to resources on the data platform 102.

The application 420 runs with its own identity in an account of a consumer 418. Specified classes of interactions require a context of the consumer 418 so that the application 420 can be authorized in the consumer account. The specified classes of interactions include, but are not limited to, account level permissions, authorize privileged actions, references, and user interactions.

A consumer action is needed to let the application 420 perform any action in an account of the consumer 418. An example action that the application 420 may perform is the creation of objects post version installation and at runtime outside the application 420, termed application objects. Some of these application objects may be made visible selectively to the consumer 418 albeit an account administrator of the consumer 418 sees everything. Examples of object creation include, but are not limited to the application 420 using an external function for its internal implementation and needing an Application Programming Interface (API) integration; an application 420 needing to create one or more databases in the account of the consumer 418, replicating an instance of another database; and the like.

An additional example action is the application 420 may need to access existing objects in the account of the consumer 418 anytime the application 420 runs. For example, an enrichment application may need SELECT and UPDATE privileges on a table in the account of the consumer 418 to read consumer data and update that table with enriched values.

An additional example action is an application needs permissions at an account level for operations performed by the application. For example, an application may need an EXECUTE TASK privilege to execute ingestion logic for a connector application at scheduled intervals.

For account level permissions, the consumer 418 grants global permissions to the application 420. In some examples, account level permissions include, but are not limited to, creating databases, executing tasks, executing managed tasks, creating data storage locations, managing storage locations, reading organization and account usage data, and the like.

For some privileged actions, the consumer 418 reviews and approves (or denies) the execution of the privileged action on behalf of the application 420. The application 420 cannot assume that these privileged actions are automatically approved when the application 420 is run. In some examples, privileged actions include, but are not limited to, creating or altering an Application Programming Interface (API) integrations, authorizing Uniform Resource Locators (URLs) for external access, creating or altering shared storage locations, authorizing accounts with which the application 420 can share objects from the consumer account, and the like.

For references, the consumer 418 grants object level permissions to the application 420 so that the application 420 can access data in the account of the consumer 418.

For user interactions, the consumer 418 interacts with the application 420 for actions such as, but not limited to, supplying names of objects such as consumer visible databases, API integrations, and the like created by the application 420 on behalf of the consumer; configuring properties of the application 420 such as refresh interval of tasks for ingestion; providing dimensions for slicing and dicing data for visualizations, and the like.

In some examples, the application 420 checks if the consumer 418 has granted permissions to the application 420 or otherwise authorized privileged actions so that the application 420 can degrade gracefully at runtime.

In some examples, the application 420 uses an application UI component 448 to request actions from the consumer and to determine if those actions have been performed by the consumer. In some examples, the application UI component 448 invokes a data platform UI component 228 executing in a trusted environment of the data platform 102. The data platform UI component 228 is used to launch a UI allowing the consumer 418 to fulfill the actions requested by the application 420. Upon acceptance by the consumer 418, the data platform UI component 228 issues Structured Query Language (SQL) commands to: i) Grant permissions, authorize privileged actions, create references. ii) Issue a request to have the application 420 do a rerun to determine changes in the access grants provided to the application 420 by the consumer 418. iii) For applications without a UI, the data platform 102 provides system level functions for the consumer 418 to create references for the application 420.

In some examples, a manifest of the consumer 418 comprises a list of one or more privileges that the application 420 may request. During operation, the application 420 can only request permissions from this list.

In some examples, the manifest includes metadata about the request such as, but not limited to, descriptive text, types of permissions, and the like that are displayed to the consumer 418 within a marketplace provided for the consumer 418 to evaluate whether the consumer 418 is willing to grant to the application 420 the privileges used by the application 420 to perform its functions.

In some examples, the data platform 102 restricts some consumer privileges from being granted to the application 420. For example, the data platform 102 may prevent granting of a CREATE API INTEGRATION privilege to the application 420 to prevent the application 420 from creating connections to resources external to data platform 102, such an external resource 422. Another example, such privilege is a CREATE SHARES privilege that may not be granted to the application 420 so as to prevent the application 420 from creating shared objects. Thus, the application 420 cannot create or alter API integrations or shared objects in the account of the consumer 418. In some examples, the data platform 102 uses references that specify a template of an object type and the privileges that the application 420 may have at runtime on objects in the account of the consumer 418 for functionality of the application 420.

The account level permissions required by the application 420 to create objects in the account of the consumer 418 and execute operations such as running tasks are declared in the manifest file along with references for referencing consumer objects. An example manifest is illustrated below:

```
privileges:
  -ingestion_task:
      privilege: EXECUTE TASK
      description: “For ingesting data on a regular cadence”
  - execute_managed_task:
      privilege: EXECUTE MANAGED TASK
      description: “For ingesting data on a regular cadence”
  - create_ingestion_db:
      privilege: CREATE DATABASE
      description: “For ingesting data in your consumer account”
  - manage_warehouses:
      privilege: MANAGE WAREHOUSES
      description: “Allows the application to suspend and resume
resources used for processing user requests”
    - access_usage_views:
      privilege: IMPORTED PRIVILEGES ON DATABASE:
      description: “For accessing org_usage and account_usage views”
references:
  - enrichment_tbl_ref:
      label: “Enrichment Table”
      description: “For enriching ESG data”
      privileges: SELECT
      object_type: TABLE
      multi_valued: true
```

In some examples, application 420 requests actions from the consumer 418 using a UI of the application 420 and checks if the actions have been fulfilled.

In some examples, if the application 420 is not granted account level permissions, the application 420 requests permissions from the user by specifying one or more permission definitions as declared in the respective manifest of the application 420.

In some examples, the application 420 can check if a reference is valid. A valid reference may be defined as an object that has been bound to the reference, the object exists, and a role that created the binding still has the right permissions on the binding. In some examples, the application 420 uses a system level command to check if a reference is valid.

In some examples, the application 420 requests the consumer 418 to create or alter an API integration. As this is a privileged action, the consumer 418 authorizes the application 420 and the application 420 has to raise this authorization request with an action.

In some examples, a specification of an API integration is provided to the UI component. The UI component generates SQL commands based on the specification including altering commands if the specification refers to an existing API integration. In some examples, the specification is written in JavaScript Object Notation (JSON). This alleviates having to pass SQL statements to the data platform UI component 228 and provides for a generic interface for use by providers who create applications.

In some examples, the application 420 can request that the consumer 418 create or alter a shared object. As this is a privileged action, the consumer 418 authorizes the application 420 to perform the action and the application 420 raises this authorization request. The UI component generates the SQL commands based on the request.

In some examples, the data platform 102 provides system functions so that applications can degrade gracefully until the application is granted permissions and other authorizations. These system functions are used by the application developers so that the application can throw appropriate errors that a consumer then can act on. Once notified, the consumer can grant permissions using normal Role Based Access Control (RBAC) grants.

In some examples, the application 420 checks for account level permissions that it has been granted using a system level function. Arguments to the function include, but are not limited to, the manifest definitions of the permissions. An example call is illustrated below:
system$check_account_permission(create_db)

In some examples, all requests for grants from the application 420 to the data platform UI component 228 are validated as to form and structure of all requests prior to taking action. The data platform 102 provides a system level function that the UI component uses to validate requests of grants of access from the application 420. An example call is illustrated below:
system$validate_permission_request(request_string)
   An access manager 202 (of FIG. 2) of the data platform 102 receives the validation request and performs a series of operations to validate the grant of access requests using a manifest of the application 420. For example, the access manager 202 decodes the request string or payload, allowing for future proofing. In some examples, the request payload is compressed or otherwise encoded to avoid overflowing a request URL. In some examples, the request payload is persisted and a token pointing to the persisted payload is sent. The access manager 202 returns a decoded request payload as a JSON record. The access manager 202 performs full schema validation of the JSON record for structural correctness and constant/enum value validation. The access manager 202 evaluates specific field values such as, but not limited to, determining URLs are completely valid with no disallowed characters, determining suggested objects names conform to identifier rules such as by avoiding certain patterns such as various Unicode space variants, and the like. The access manager 202 tracks and presents failed validations for threat detection to a threat detection component (not shown) of the data platform 102.

In some examples, the application 420 can determine whether it has a set of account level permissions with commands such as:
permission.get_held_account_privileges([priv])
permission.get_missing_account_privileges([priv])
   where [priv] is a list of privileges. The first function checks all passed privileges and returns the list of privileges currently being held by the application 420 (or missing). The second function returns privileges that are missing from the application 420.

In some examples, the UI component, upon receiving a request from the application 420, can execute a “SHOW PRIVILEGES IN APPLICATION” command to determine a complete set of privileges defined in the manifest, along with their description and current state (granted/not granted). If specific privileges were requested in the request, but are not among the privileges returned from the SHOW command, a dialog will show a warning message to the consumer 418, indicating that the application is attempting to request a privilege that it did not declare in its respective manifest that it will request. In some examples, the UI component uses an “is_grantable” field to disable privileges a current role cannot approve.

In some examples, a consumer having a system administrator role can edit a set of privileges of the application 420 from a single UI of the data platform UI component 228.

FIG. 4B is a sequence diagram of an access granting method 400c used by the components of the data platform 102, and FIG. 4C is an activity diagram of the access granting method 400c, in accordance with some examples. A data platform 102 (of FIG. 1) uses the access granting method 400c to provide for an application 420 to request and receive grants of privileges to access one or more resources of the data platform 102 and external resources.

Although the example access granting method 400c depicts a particular sequence of operations, the sequence may be altered without departing from the scope of the present disclosure. For example, some of the operations depicted may be performed in parallel or in a different sequence that does not materially affect the function of the access granting method 400c. In other examples, different components of an example device or system that implements the access granting method 400c may perform functions at substantially the same time or in a specific sequence.

In operation 402, the application 420 queries for granted privileges to access resources. For example, the application 420 queries an access manager 202 of the data platform 102 for one or more privileges that have been granted to the application 420 for accessing resources using a system level function. Arguments to the system level function include, but are not limited to, the manifest definitions of the privileges that the application 420 needs to perform the functions of the application 420. An example use of the system level function is illustrated below. The example use is for a privilege query 436 of whether the 420 has been granted a privilege to create a database:
system$check_account_permission(“CREATE DATABASE”)
   The access manager 202 receives the privilege query 436, determines whether the application 420 has been granted the one or more privileges and now holds the one or more privileges as described above. The access manager 202 responds with a query response 438 indicating whether the application 420 holds the one or more privileges. The application 420 receives the query response 438 and uses the query response 438 to determine whether the application 420 holds the one or more privileges.

In operation 404, in response to determining that the application 420 does not hold one or more of the one or more privileges, application requests grants of the privileges needed to access the resources. For example, the application 420 transmits a grant of privileges request 428 to a UI component 228 of the data platform 102 requesting that the application 420 be granted one or more privileges. In some examples, the application 420 calls the data platform UI component 228 as illustrated below. In the example call, the application 420 requests account privileges of creating a database and executing a task on the data platform 102 within an account of the consumer 418:
permission.request_account_privileges([“CREATE DATABASE”, “EXECUTE TASK”])

The data platform UI component 228 receives the grant of privileges request 428 and, in operation 406, the data platform UI component 228 requests validation of the grant of privileges request 428. For example, the data platform UI component 228 transmits a validation request 440 to the access manager 202. In some examples, the data platform UI component 228 uses a system level function as illustrated below to transmit the validation request 440 to the access manager 202. When using the system level function, the data platform UI component 228 includes the grant of privileges request 428 received from the application 420 to be validated:
system$validate_permission_request(request string)
   In response to receiving the validation request 440, the access manager 202 validates that the application 420 is entitled to have the grants of one or more privileges as indicated in the grant of privileges request 428 using the manifest of the application 420 and a process described above in reference to FIG. 4A. The access manager 202 generates a validated response 442 and communicates the validated response 442 to the data platform UI component 228. The validated response 442 includes an indication of one or more privileges that the application 420 is entitled to. The data platform UI component 228 receives the validated response 442.

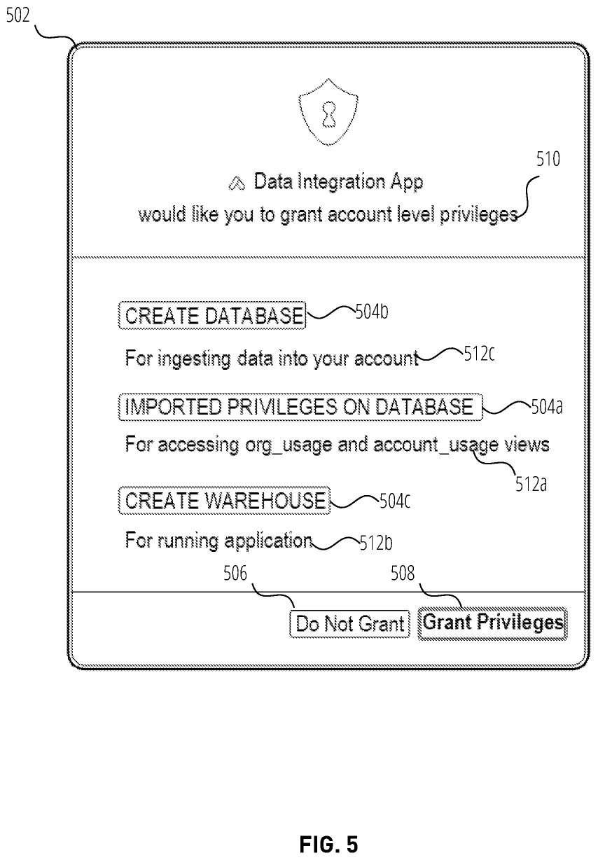

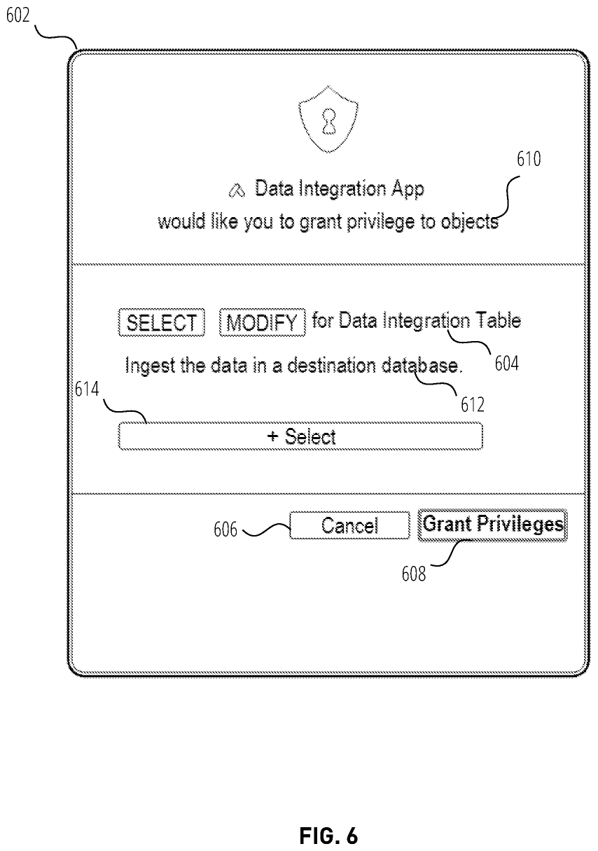

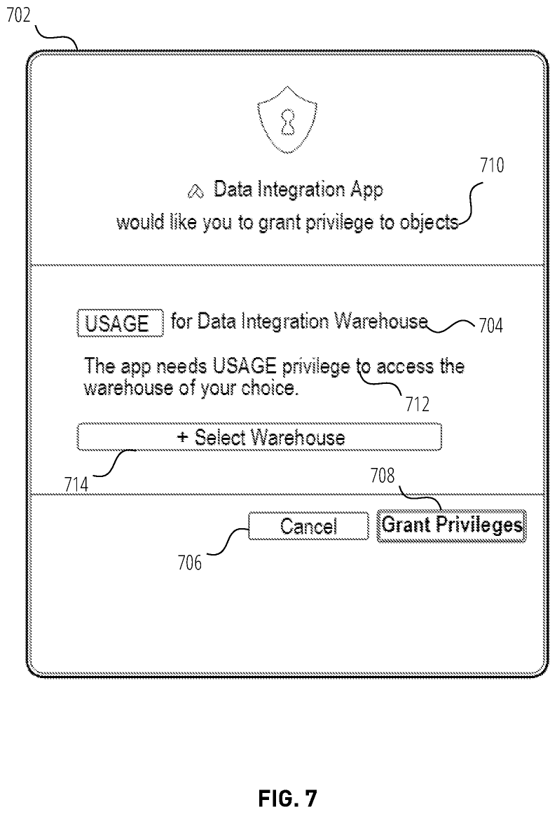

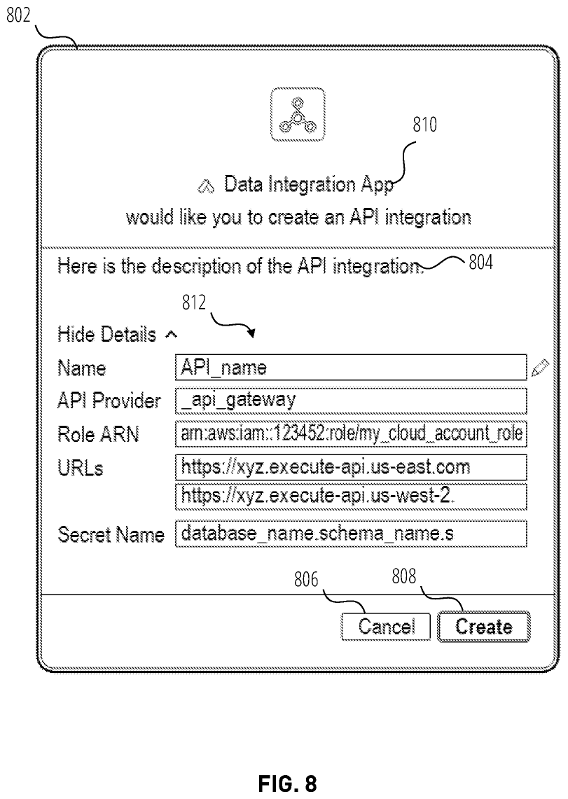

In operation 408, the data platform UI component 228 generates a grant privilege request UI 430 using the validated response 442 and presents that grant privilege request UI 430 to the consumer 418. Example grant privilege request UIs are illustrated in more detail in FIG. 5, FIG. 6, FIG. 7, and FIG. 8.

In operation 410, the data platform UI component 228 receives one or more privilege grant authorization 432 from the consumer 418. For example, the consumer 418 uses the grant privilege request UI 430 to make one or more selections of authorizations to grant one or more privileges to the application 420.

In operation 412, the data platform UI component 228 requests grants of privileges to the application 420 using the privilege grant authorization 432. For example, the data platform UI component 228 transmits a grant privileges request 444 to the access manager 202. The access manager 202 receives the grant privileges request 444 and grants one or more privileges to the application 420 using the grant privileges request 444. In some examples, the data platform UI component 228 uses a SQL command as indicated below to grant a privilege to the application 420:
GRANT <privilege> ON <object> TO APPLICATION <app_name>

In operation 414, the application 420 determines if the application 420 has been granted the requested privileges. For example, the application 420 polls the access manager 202 using a granted privilege request 446 and receives a grant notification message 434 listing including none or more privileges that have been granted to the application 420 by the consumer 418. In some examples, the data platform UI component 228 transmits the grant notification message 434 to the application 420 directly.

In operation 416, the application 420 uses the one or more granted privileges to access one or more resources. For example, if the application 420 has received a privilege to use an API integration 424 to access an external resource 422, the application 420 accesses the external resource 422. As another example, if the application 420 has been granted a privilege to access or create one or more objects 426, the application 420 accesses or creates those objects using the granted privileges.

FIG. 5 is an illustration of an account privileges request UI 502 for requesting a grant of an account privilege, in accordance with some examples.

In some examples, an application 420 (of FIG. 4A) requests a grant of an account privilege using an account privilege request such as:
permission.request_account_privileges([“CREATE DATABASE”, “EXECUTE TASK”])

In response to the request, a UI component 228 (of FIG. 2) of a data platform 102 (of FIG. 1) validates the privilege request (as more fully described in reference to FIG. 4A and FIG. 4B) generates the account privileges request UI 502 and presents it to a consumer. The account privileges request UI 502 implements a dialog to be presented to the consumer requesting that the privileges that are defined in a manifest of the application 420 to be granted. The privileges argument will cause the resulting dialog to highlight the privileges that are specifically being requested by the application 420. The account privileges request UI 502 comprises a prompt 510 identifying an application requesting the account privilege. The account privileges request UI 502 further comprises one or more privilege identifications, such as privilege identification 504a, privilege identification 504b, and privilege identification 504c identifying one or more account privileges that the identified application is requesting. The account privileges request UI 502 further comprises one or more reasons for the privilege requests, such as reason for privilege request 512a, reason for privilege request 512b, and reason for privilege request 512c.

The account privileges request UI 502 further comprises a “do not grant” selection button 506 for the consumer to select to deny the account privileges request, and a “grant privileges” selection button 508 for the consumer to select to grant the account privileges request.

FIG. 6 is an illustration of a reference request UI 602 for requesting a reference fulfillment to access to one or more objects using references, in accordance with some examples.

In some examples, an application 420 (of FIG. 4A) requests a reference fulfillment using a reference fulfillment request such as:
config.request_reference(“ref_name_1”)

In some examples, object types that may be used in references include, but are not limited to, tables, views, external tables, functions, procedures, storage locations, API integrations, notification integrations, and the like.

In response to the request, a UI component 228 (of FIG. 2) of a data platform 102 (of FIG. 1) generates the reference request UI 602 and presents it to a consumer. The reference request UI 602 implements a dialog to be presented to the consumer requesting that the privileges that are defined in a manifest of the application 420 to be granted. The reference request UI 602 comprises a prompt 610 identifying an application requesting the privileges. The reference request UI 602 further comprises one or more privilege identifications, such as privilege identification 604, identifying one or more privileges that the identified application is requesting. The reference request UI 602 further comprises one or more reasons for the privilege requests, such as reason for privilege request 612.

The reference request UI 602 further includes a “+Select” button 614 selectable by the consumer to select from existing objects of the requested type (e.g., table and the like) from the data platform for which the consumer has access. Any privileges granted will also apply to the selected objects.

The reference request UI 602 further comprises a “cancel” selection button 606 for the consumer to select to deny the account privileges request, and a “grant privileges” selection button 608 for the consumer to select to grant the privileges request.

In some examples, when references are fulfilled by UI component 228, a selected object is bound within the application 420 system calls such as, but not limited to, “system$set_reference”, “system$add_reference functions”, and the like. As these functions cannot be invoked from outside of the application 420, setting of bindings is performed through callback procedures.

In some examples, the application 420 can test if a given reference is bound, using:
config.get_reference_associations(<reference_name>).

FIG. 7 is an illustration of an object access request UI 702 for requesting privileges to one or more objects, in accordance with some examples.

In some examples, an application 420 (of FIG. 4A) requests privileges used to access one or more objects within an account of a consumer such as, but not limited to, tables, views, external tables, functions, procedures, storage locations, API integrations, notification integrations, and the like.

In response to the request, a UI component 228 (of FIG. 2) of a data platform 102 (of FIG. 1) generates the object access request UI 702 and presents it to a consumer. The object access request UI 702 implements a dialog to be presented to the consumer requesting that the privileges that are defined in a manifest of the application 420 to be granted. The object access request UI 702 comprises a prompt 710 identifying an application requesting the privileges. The object access request UI 702 further comprises one or more privilege identifications, such as privilege identification 704, identifying one or more privileges that the identified application is requesting. The object access request UI 702 further comprises one or more reasons for the privilege requests, such as reason for privilege request 712. The reference request UI 702 further includes a “+Select Warehouse” button 614 selectable by the consumer to select from existing objects of the requested type (e.g., virtual warehouses and the like) from the data platform for which the consumer has access. Any privileges granted will also apply to the selected objects.

The object access request UI 702 further comprises a “cancel” selection button 706 for the consumer to select to deny the account privileges request, and a “grant privileges” selection button 708 for the consumer to select to grant the privileges request.

In some examples, the application 420 requests the creation of a shared database with the following:
config.request_share(<name>, <share_db>, <db_role>, <accounts>))

### Where:

name—the proposed name for the shared object, the consumer is free to ignore/change this
share_db—The name of the object to share. In some examples, this is an object that is owned by the application 420 and may not be the application itself
db_role—The name of a database role in the database to be shared. The application 420 will use this role to add content to the share.

When a data platform UI component 228 (of FIG. 2) receives the request, the data platform UI component 228 validates that the target database and database roles exist are owned by the application 420. In some examples, a consumer must have an application role that makes these things visible. The data platform UI component 228 prompts the user for the creation and creates the target database if the consumer agrees.

FIG. 8 is an illustration of an API integration request UI 802 for requesting the use of an API integration to an external resource, in accordance with some examples.

An application 420 (of FIG. 4A) can request to use an API integration to access an external resource. In response to a request to use an API integration, a UI component 228 (of FIG. 2) of a data platform 102 (of FIG. 1) generates the API integration request UI 802 and presents it to a consumer. The API integration request UI 802 implements a dialog to be presented to the consumer requesting to use an API integration defined in a manifest of the application 420. The API integration request UI 802 comprises a prompt 810 identifying an application requesting the privileges. The API integration request UI 802 further comprises one or more privilege identifications, such as API integration description 804, identifying one or more privileges that the identified application is requesting. The API integration request UI 802 further comprises one or more reasons for the privilege requests, such as API integration details 812.

The API integration request UI 802 further comprises a “cancel” selection button 806 for the consumer to select to deny the account privileges request, and a “grant privileges” selection button 808 for the consumer to select to grant the privileges request.

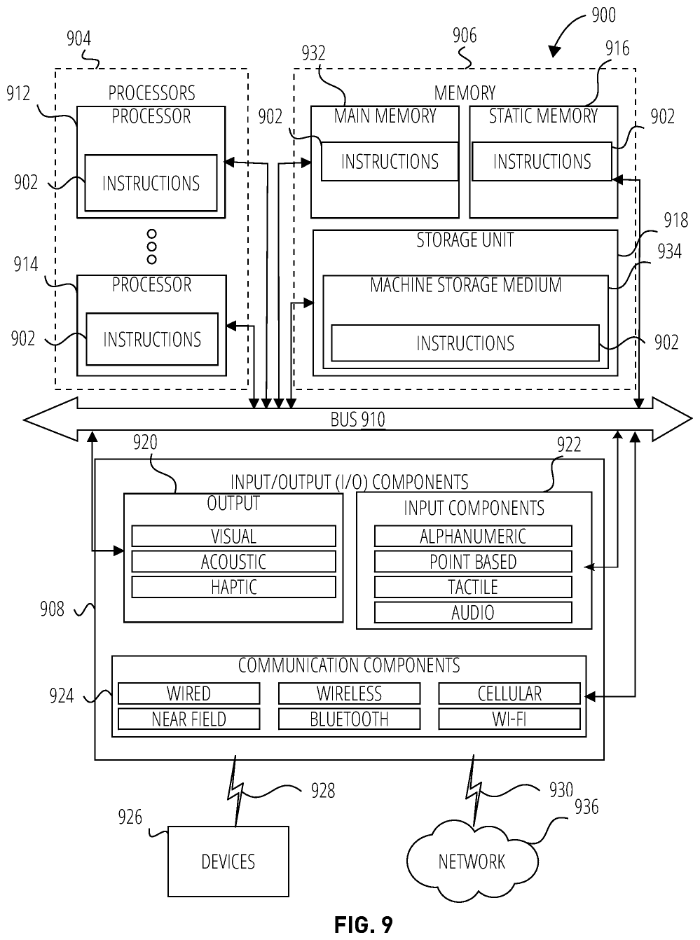

FIG. 9 illustrates a diagrammatic representation of a machine 900 in the form of a computer system within which a set of machine-readable instructions may be executed for causing the machine 900 to perform any one or more of the methodologies discussed herein, according to examples. Specifically, FIG. 9 shows a diagrammatic representation of the machine 900 in the example form of a computer system, within which computer-readable instructions 902 (e.g., software, a program, an application, an applet, a data application, or other executable code) for causing the machine 900 to perform any one or more of the methodologies discussed herein may be executed. For example, the instructions 902 may cause the machine 900 to execute any one or more operations of any one or more of the methods described herein. In this way, the instructions 902 transform a general, non-programmed machine into a particular machine 900 (e.g., the compute service manager 104, the execution platform 110, and the data storage devices 1 to N of data storage 106) that is specially configured to carry out any one of the described and illustrated functions in the manner described herein.

In alternative examples, the machine 900 operates as a standalone device or may be coupled (e.g., networked) to other machines. In a networked deployment, the machine 900 may operate in the capacity of a server machine or a client machine in a server-client network environment, or as a peer machine in a peer-to-peer (or distributed) network environment. The machine 900 may comprise, but not be limited to, a server computer, a client computer, a personal computer (PC), a tablet computer, a laptop computer, a netbook, a smart phone, a mobile device, a network router, a network switch, a network bridge, or any machine capable of executing the instructions 902, sequentially or otherwise, that specify actions to be taken by the machine 900. Further, while only a single machine 900 is illustrated, the term “machine” shall also be taken to include a collection of machines that individually or jointly execute the instructions 902 to perform any one or more of the methodologies discussed herein.

The machine 900 includes processors 904, memory 906, and I/O components 908 configured to communicate with each other such as via a bus 910. In some examples, the processors 904 (e.g., a central processing unit (CPU), a reduced instruction set computing (RISC) processor, a complex instruction set computing (CISC) processor, a graphics processing unit (GPU), a digital signal processor (DSP), an application-specific integrated circuit (ASIC), a radio-frequency integrated circuit (RFIC), another processor, or any suitable combination thereof) may include, for example, multiple processors as exemplified by processor 912 and a processor 914 that may execute the instructions 902. The term “processor” is intended to include multi-core processors that may comprise two or more independent processors (sometimes referred to as “cores”) that may execute instructions 902 contemporaneously. Although FIG. 9 shows multiple processors 904, the machine 900 may include a single processor with a single core, a single processor with multiple cores (e.g., a multi-core processor), multiple processors with a single core, multiple processors with multiple cores, or any combination thereof.

The memory 906 may include a main memory 932, a static memory 916, and a storage unit 918 including a machine storage medium 934, all accessible to the processors 904 such as via the bus 910. The main memory 932, the static memory 916, and the storage unit 918 store the instructions 902 embodying any one or more of the methodologies or functions described herein. The instructions 902 may also reside, completely or partially, within the main memory 932, within the static memory 916, within the storage unit 918, within at least one of the processors 904 (e.g., within the processor's cache memory), or any suitable combination thereof, during execution thereof by the machine 900.

The input/output (I/O) components 908 include components to receive input, provide output, produce output, transmit information, exchange information, capture measurements, and so on. The specific I/O components 908 that are included in a particular machine 900 will depend on the type of machine. For example, portable machines such as mobile phones will likely include a touch input device or other such input mechanisms, while a headless server machine will likely not include such a touch input device. It will be appreciated that the I/O components 908 may include many other components that are not shown in FIG. 9. The I/O components 908 are grouped according to functionality merely for simplifying the following discussion and the grouping is in no way limiting. In various examples, the I/O components 908 may include output components 920 and input components 922. The output components 920 may include visual components (e.g., a display such as a plasma display panel (PDP), a light emitting diode (LED) display, a liquid crystal display (LCD), a projector, or a cathode ray tube (CRT)), acoustic components (e.g., speakers), other signal generators, and so forth. The input components 922 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and/or force of touches or touch gestures, or other tactile input components), audio input components (e.g., a microphone), and the like.

Communication may be implemented using a wide variety of technologies. The I/O components 908 may include communication components 924 operable to couple the machine 900 to a network 936 or devices 926 via a coupling 930 and a coupling 928, respectively. For example, the communication components 924 may include a network interface component or another suitable device to interface with the network 936. In further examples, the communication components 924 may include wired communication components, wireless communication components, cellular communication components, and other communication components to provide communication via other modalities. The devices 926 may be another machine or any of a wide variety of peripheral devices (e.g., a peripheral device coupled via a universal serial bus (USB)). For example, as noted above, the machine 900 may correspond to any one of the compute service manager 104, the execution platform 110, and the devices 926 may include the data storage device 226 or any other computing device described herein as being in communication with the data platform 102 or the data storage 106.

The various memories (e.g., 906, 916, 932, and/or memory of the processor(s) 904 and/or the storage unit 918) may store one or more sets of instructions 902 and data structures (e.g., software) embodying or utilized by any one or more of the methodologies or functions described herein. These instructions 902, when executed by the processor(s) 904, cause various operations to implement the disclosed examples.

As used herein, the terms “machine-storage medium,” “device-storage medium,” and “computer-storage medium” mean the same thing and may be used interchangeably in this disclosure. The terms refer to a single or multiple storage devices and/or media (e.g., a centralized or distributed database, and/or associated caches and servers) that store executable instructions and/or data. The terms shall accordingly be taken to include, but not be limited to, solid-state memories, and optical and magnetic media, including memory internal or external to processors. Specific examples of machine-storage media, computer-storage media, and/or device-storage media include non-volatile memory, including by way of example semiconductor memory devices, e.g., erasable programmable read-only memory (EPROM), electrically erasable programmable read-only memory (EEPROM), field-programmable gate arrays (FPGAs), and flash memory devices; magnetic disks such as internal hard disks and removable disks; magneto-optical disks; and CD-ROM and DVD-ROM disks. The terms “machine-storage media,” “computer-storage media,” and “device-storage media” specifically exclude carrier waves, modulated data signals, and other such media, at least some of which are covered under the term “signal medium” discussed below.

In various examples, one or more portions of the network 936 may be an ad hoc network, an intranet, an extranet, a virtual private network (VPN), a local-area network (LAN), a wireless LAN (WLAN), a wide-area network (WAN), a wireless WAN (WWAN), a metropolitan-area network (MAN), the Internet, a portion of the Internet, a portion of the public switched telephone network (PSTN), a plain old telephone service (POTS) network, a cellular telephone network, a wireless network, a Wi-Fi® network, another type of network, or a combination of two or more such networks. For example, the network 936 or a portion of the network 936 may include a wireless or cellular network, and the coupling 930 may be a Code Division Multiple Access (CDMA) connection, a Global System for Mobile communications (GSM) connection, or another type of cellular or wireless coupling. In this example, the coupling 930 may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, fifth generation wireless (5G) networks, Universal Mobile Telecommunications System (UMTS), High-Speed Packet Access (HSPA), Worldwide Interoperability for Microwave Access (WiMAX), Long Term Evolution (LTE) standard, others defined by various standard-setting organizations, other long-range protocols, or other data transfer technology.

The instructions 902 may be transmitted or received over the network 936 using a transmission medium via a network interface device (e.g., a network interface component included in the communication components 924) and utilizing any one of a number of well-known transfer protocols (e.g., hypertext transfer protocol (HTTP)). Similarly, the instructions 902 may be transmitted or received using a transmission medium via the coupling 928 (e.g., a peer-to-peer coupling) to the devices 926. The terms “transmission medium” and “signal medium” mean the same thing and may be used interchangeably in this disclosure. The terms “transmission medium” and “signal medium” shall be taken to include any intangible medium that is capable of storing, encoding, or carrying the instructions 902 for execution by the machine 900, and include digital or analog communications signals or other intangible media to facilitate communication of such software. Hence, the terms “transmission medium” and “signal medium” shall be taken to include any form of modulated data signal, carrier wave, and so forth. The term “modulated data signal” means a signal that has one or more of its characteristics set or changed in such a manner as to encode information in the signal.

The various operations of example methods described herein may be performed, at least partially, by one or more processors that are temporarily configured (e.g., by software) or permanently configured to perform the relevant operations. Similarly, the methods described herein may be at least partially processor-implemented. For example, at least some of the operations of the methodologies disclosed herein may be performed by one or more processors. The performance of certain of the operations may be distributed among the one or more processors, not only residing within a single machine, but also deployed across a number of machines. In some examples, the processor or processors may be located in a single location (e.g., within a home environment, an office environment, or a server farm), while in other examples the processors may be distributed across a number of locations.

Additional examples include:

Example 1 is a computer-implemented method comprising: determining, by at least one processor, whether a privilege for accessing a resource of a data platform has been granted to an application of the data platform; and in response to determining that the privilege has not been granted to the application, performing operations comprising: receiving, by the at least one processor, a request to grant the privilege to the application; generating, by the at least one processor, a validation of the request to grant the privilege to the application using a manifest of the application; and in response to the validation, performing operations comprising: generating, by the at least one processor, a grant privilege request UI using the request to grant the privilege; presenting, by the at least one processor, the grant privilege request UI to a consumer of the data platform; receiving, by the at least one processor, a privilege grant authorization from the consumer; granting, by the at least one processor, the privilege to the application; and using, by the at least one processor, the privilege to use the resource.

In Example 2, the subject matter of Example 1 includes, wherein the resource comprises an account privilege.

In Example 3, the subject matter of any of Examples 1-2 includes, wherein the resource comprises an object managed by the data platform.

In Example 4, the subject matter of any of Examples 1-3 includes, wherein the manifest specifies one or more privileges that the application is permitted to request.

In Example 5, the subject matter of any of Examples 1-4 includes, wherein generating the validation comprises decoding a request payload and validating a structure of the request.

In Example 6, the subject matter of any of Examples 1-5 includes, wherein presenting the grant privilege request interface comprises highlighting privileges specifically requested by the application.

In Example 7, the subject matter of any of Examples 1-6 includes, wherein granting the privilege comprises using a SQL command to grant the privilege to the application.

In Example 8, the subject matter of any of Examples 1-7 includes, in response to determining the privilege has been granted, allowing the application to access the resource.

In Example 9, the subject matter of any of Examples 1-8 includes, wherein generating the grant privilege request UI further comprises: retrieving metadata associated with the requested privilege from the manifest, the metadata comprising at least one of: a description of the requested privilege, a type of the requested privilege, or a reason for the requested privilege; and displaying the metadata to the consumer along with the grant privilege request UI.

In Example 10, the subject matter of any of Examples 1-9 includes, wherein the consumer comprises an administrator user of an account on the data platform.

Example 11 is at least one machine-readable medium including instructions that, when executed by processing circuitry, cause the processing circuitry to perform operations to implement any of Examples 1-10.

Example 12 is an apparatus comprising means to implement any of Examples 1-10.

Example 13 is a system to implement any of Examples 1-10.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended; that is, a system, device, article, or process that includes elements in addition to those listed after such a term in a claim is still deemed to fall within the scope of that claim.

Although the examples of the present disclosure have been described with reference to specific examples, it will be evident that various modifications and changes may be made to these examples without departing from the broader scope of the inventive subject matter. Accordingly, the specification and drawings are to be regarded in an illustrative rather than a restrictive sense. The accompanying drawings that form a part hereof show, by way of illustration, and not of limitation, specific examples in which the subject matter may be practiced. The examples illustrated are described in sufficient detail to enable those skilled in the art to practice the teachings disclosed herein. Other examples may be used and derived therefrom, such that structural and logical substitutions and changes may be made without departing from the scope of this disclosure. This Detailed Description, therefore, is not to be taken in a limiting sense, and the scope of various examples is defined only by the appended claims, along with the full range of equivalents to which such claims are entitled.

Such examples of the inventive subject matter may be referred to herein, individually and/or collectively, by the term “example” merely for convenience and without intending to voluntarily limit the scope of this application to any single invention or inventive concept if more than one is in fact disclosed. Thus, although specific examples have been illustrated and described herein, it should be appreciated that any arrangement calculated to achieve the same purpose may be substituted for the specific examples shown. This disclosure is intended to cover any and all adaptations or variations of various examples. Combinations of the above examples, and other examples not specifically described herein, will be apparent to those of skill in the art, upon reviewing the above description.

What is claimed is:

1. A computer-implemented method comprising:
determining, by at least one processor, whether a privilege for accessing a resource of a data platform has been granted to an application of the data platform; and
in response to determining that the privilege has not been granted to the application, performing operations comprising:
receiving, by the at least one processor, a request to grant the privilege to the application;
generating, by the at least one processor, a validation of the request to grant the privilege to the application using a manifest of the application; and
in response to the validation, performing operations comprising:
generating, by the at least one processor, a grant privilege request User Interface (UI) using the request to grant the privilege;
presenting, by the at least one processor, the grant privilege request UI to a consumer of the data platform;
receiving, by the at least one processor, a privilege grant authorization from the consumer;
granting, by the at least one processor, the privilege to the application; and
using, by the at least one processor, the privilege to use the resource.

2. The computer-implemented method of claim 1, wherein the resource comprises an account privilege.

3. The computer-implemented method of claim 1, wherein the resource comprises an object managed by the data platform.

4. The computer-implemented method of claim 1, wherein the manifest specifies one or more privileges that the application is permitted to request.

5. The computer-implemented method of claim 1, wherein generating the validation comprises decoding a request payload and validating a structure of the request.

6. The computer-implemented method of claim 1, wherein presenting the grant privilege request UI comprises highlighting privileges specifically requested by the application.

7. The computer-implemented method of claim 1, wherein granting the privilege comprises using a SQL command to grant the privilege to the application.

8. The computer-implemented method of claim 1, further comprising: in response to determining the privilege has been granted, allowing the application to access the resource.

9. The computer-implemented method of claim 1, wherein generating the grant privilege request UI further comprises:
retrieving metadata associated with the requested privilege from the manifest, the metadata comprising at least one of: a description of the requested privilege, a type of the requested privilege, or a reason for the requested privilege; and
displaying the metadata to the consumer along with the grant privilege request UI.

10. The computer-implemented method of claim 1, wherein the consumer comprises an administrator user of an account on the data platform.

11. A data platform comprising:
at least one processor; and
at least one memory storing instructions that, when executed by the at least one processor, cause the data platform to perform operations comprising:
determining, by at least one processor, whether a privilege for accessing a resource of a data platform has been granted to an application of the data platform; and
in response to determining that the privilege has not been granted to the application, performing operations comprising:
receiving, by the at least one processor, a request to grant the privilege to the application;
generating, by the at least one processor, a validation of the request to grant the privilege to the application using a manifest of the application; and
in response to the validation, performing operations comprising:
generating, by the at least one processor, a grant privilege request UI using the request to grant the privilege;
presenting, by the at least one processor, the grant privilege request UI to a consumer of the data platform;
receiving, by the at least one processor, a privilege grant authorization from the consumer;
granting, by the at least one processor, the privilege to the application; and
using, by the at least one processor, the privilege to use the resource.

12. The data platform of claim 11, wherein the resource comprises an account privilege.

13. The data platform of claim 11, wherein the resource comprises an object managed by the data platform.

14. The data platform of claim 11, wherein the manifest specifies one or more privileges that the application is permitted to request.

15. The data platform of claim 11, wherein generating the validation comprises decoding a request payload and validating a structure of the request.

16. The data platform of claim 11, wherein presenting the grant privilege request UI comprises highlighting privileges specifically requested by the application.

17. The data platform of claim 11, wherein granting the privilege comprises using a SQL command to grant the privilege to the application.

18. The data platform of claim 11, wherein the operations further comprise:
in response to determining the privilege has been granted, allowing the application to access the resource.

19. The data platform of claim 11, wherein generating the grant privilege request UI further comprises:
retrieving metadata associated with the requested privilege from the manifest, the metadata comprising at least one of: a description of the requested privilege, a type of the requested privilege, or a reason for the requested privilege; and
displaying the metadata to the consumer along with the grant privilege request UI.

20. The data platform of claim 11, wherein the consumer comprises an administrator user of an account on the data platform.

21. A machine-storage medium comprising machine-readable instructions that, when executed by a machine, cause the machine to perform operations comprising:
determining, by at least one processor, whether a privilege for accessing a resource of a data platform has been granted to an application of the data platform; and
in response to determining that the privilege has not been granted to the application, performing operations comprising:
receiving, by the at least one processor, a request to grant the privilege to the application;
generating, by the at least one processor, a validation of the request to grant the privilege to the application using a manifest of the application; and
in response to the validation, performing operations comprising:
generating, by the at least one processor, a grant privilege request UI using the request to grant the privilege;
presenting, by the at least one processor, the grant privilege request UI to a consumer of the data platform;
receiving, by the at least one processor, a privilege grant authorization from the consumer;
granting, by the at least one processor, the privilege to the application; and
using, by the at least one processor, the privilege to use the resource.

22. The machine-storage medium of claim 21, wherein the resource comprises an account privilege.

23. The machine-storage medium of claim 21, wherein the resource comprises an object managed by the data platform.

24. The machine-storage medium of claim 21, wherein the manifest specifies one or more privileges that the application is permitted to request.

25. The machine-storage medium of claim 21, wherein generating the validation comprises decoding a request payload and validating a structure of the request.

26. The machine-storage medium of claim 21, wherein presenting the grant privilege request UI comprises highlighting privileges specifically requested by the application.

27. The machine-storage medium of claim 21, wherein granting the privilege comprises using a SQL command to grant the privilege to the application.

28. The machine-storage medium of claim 21, wherein the operations further comprise:
in response to determining the privilege has been granted, allowing the application to access the resource.

29. The machine-storage medium of claim 21, wherein generating the grant privilege request UI further comprises:
retrieving metadata associated with the requested privilege from the manifest, the metadata comprising at least one of: a description of the requested privilege, a type of the requested privilege, or a reason for the requested privilege; and
displaying the metadata to the consumer along with the grant privilege request UI.

30. The machine-storage medium of claim 21, wherein the consumer comprises an administrator user of an account on the data platform.
